(19) United States
(12) Patent Application Publication
(10) Pub. No.: US 2012/0141755 A1
(43) Pub. Date: Jun. 7, 2012

(54) Metal Member and Manufacturing Method Thereof

(75) Inventors: Yau-Hung Chiou, Taipei City (TW); Shu-Hui Fan, Guanxi Township (TW)

(73) Assignee: CHENMING MOLD IND. CORP., Taipei City (TW)

(21) Appl. No.: 13/019,475

(22) Filed: Feb. 2, 2011

(30) Foreign Application Priority Data
Dec. 3, 2010 (TW) 099142189

(51) Int. Cl. B32B 15/04; B05D 3/10; B32B 7/02

(52) U.S. Cl. 428/213; 428/457; 428/336; 427/535

(57) ABSTRACT

The present invention discloses a metal member and a manufacturing method thereof. The metal member comprises a metal substrate and an intermediate layer. Wherein, the intermediate layer is disposed on the metal substrate by vacuum depositing, and the intermediate layer is a carbonized metal. Preferably, the intermediate layer could have a composition gradient or a thickness gradient to further increase the adhesion between the metal layer deposited on the metal substrate.

### FIELD

The exemplary embodiment(s) of the present invention relates to a field of a metal member and a manufacturing method thereof. More specifically, the exemplary embodiment(s) of the present invention relates to a metal member having a carbonized metal layer with a composition gradient and a manufacturing method thereof.

### BACKGROUND

The conventional metal housing is often deposited a metal layer as a decorating layer. However, due to the highly difference of the lattice parameters of the metals, there is a residual stress on the heterogeneous interface, and thus the decorating layer is easy to fall off from the metal housing, and the appearance of the conventional consumer electronic thus is not tried-and-true.

The conventional method of depositing the metal film comprises electroplates and arc-deposition, however the adhesive ability of these metal films is not raised by these methods. Thus, providing an intermediate layer having highly adhesive ability disposed between the metal decorating layer and the substrate and a manufacturing thereof seems could not be further delayed.

### SUMMARY

To solve the problems in the conventional arts, it is a primary object of the present invention to provide a metal member and a manufacturing method thereof to solve the problem that the adhesion insufficient between the metal housing and the metal deposited thereon.

To achieve the above object, a metal member according to the present invention comprises a metal substrate and an intermediate layer. The intermediate layer is disposed on one side of the metal substrate, and the intermediate layer is a carbonized metal (MₓC_{y}).

Wherein the intermediate layer further comprises a first sub-intermediate layer (MₐC_{b}) and a second sub-intermediate layer (M_{c}C_{d}). The first sub-intermediate layer is disposed on the side of the metal substrate, and the second sub-intermediate layer is disposed on the first sub-intermediate layer, and a+b=1, c+d=1 and a<c.

Wherein the intermediate layer further comprises a first sub-intermediate layer and a second sub-intermediate layer. The first sub-intermediate layer is disposed on the side of the metal substrate, and the second sub-intermediate layer is disposed on the first sub-intermediate layer, and the thickness of the first sub-intermediate layer is less than the thickness of the second sub-intermediate layer.

Wherein the intermediate layer further comprises a first sub-intermediate layer and a second sub-intermediate layer. The first sub-intermediate layer is disposed on the side of the metal substrate, and the second sub-intermediate layer is disposed on the first sub-intermediate layer, and the thickness of the first sub-intermediate layer is bigger than the thickness of the second sub-intermediate layer.

Wherein the thickness of the intermediate layer is 1˜5 nm.

Wherein the metal member further comprises a metal layer disposed on the intermediate layer.

To achieve another object, a metal member manufacturing method according to the present invention comprises the following steps of: providing a metal substrate; bombarding one side of the metal substrate by plasma; and reactively depositing an intermediate layer on the side of the metal substrate by vacuum deposition, and the intermediate layer being a carbonized metal (MₓC_{y}).

Wherein the step of depositing the intermediate layer further comprises: depositing a first sub-intermediate layer (MₐC_{b}) on the side of the metal substrate; and depositing a second sub-intermediate layer (M_{c}C_{d}) on the first sub-intermediate layer. Wherein, a+b=1, c+d=1 and a<c.

Wherein the step of depositing the intermediate layer further comprises: depositing a first sub-intermediate layer on the side of the metal substrate; and depositing a second sub-intermediate layer on the first sub-intermediate layer. Wherein, the thickness of the first sub-intermediate layer is less than the thickness of the second sub-intermediate layer.

Wherein the step of depositing the intermediate layer further comprises: depositing a first sub-intermediate layer on the side of the metal substrate; and depositing a second sub-intermediate layer on the first sub-intermediate layer. Wherein, the thickness of the first sub-intermediate layer is bigger than the thickness of the second sub-intermediate layer.

Wherein the working pressure of the plasma bombardment and the vacuum deposition is 10⁻²˜10⁻⁴ Pa.

Wherein the argon and an organic gas are provided as the plasma gas during the vacuum deposition.

Wherein the organic gas is methane or acetylene.

Wherein the thickness of the intermediate layer is 1˜5 nm.

Wherein the method further comprises: depositing a metal layer on the intermediate layer by vacuum deposition.

With the above arrangements, the metal member and the manufacturing method thereof according to the present invention has one or more of the following advantages:

(1) The adhesion between the deposited metal materials and the metal substrate could be increased by disposing an intermediate layer between the deposited metal materials and the metal substrate in accordance with the present invention.

(2) The problem of the prior art that the deposited metal materials could not fix on the metal substrate could be solved by gradually changing the composition or the thickness of the intermediate layer in accordance with the present invention.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a flow chart of the metal member manufacturing method in accordance with the present invention;

FIG. 2 illustrates another flow chart of the metal member manufacturing method in accordance with the present invention;

FIG. 3 illustrates still another flow chart of the metal member manufacturing method in accordance with the present invention;

FIG. 4 illustrates a schematic diagram of the metal member manufacturing method in accordance with the present invention;

FIG. 5 illustrates a schematic diagram of the first embodiment of the metal member in accordance with the present invention;

FIG. 6 illustrates a schematic diagram of the second embodiment of the metal member in accordance with the present invention;

FIG. 7 illustrates a schematic diagram of the third embodiment of the metal member in accordance with the present invention; and

FIG. 8 illustrates a schematic diagram of the fourth embodiment of the metal member in accordance with the present invention.

### DETAILED DESCRIPTION

Exemplary embodiments of the present invention are described herein in the context of a metal member and a manufacturing method thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

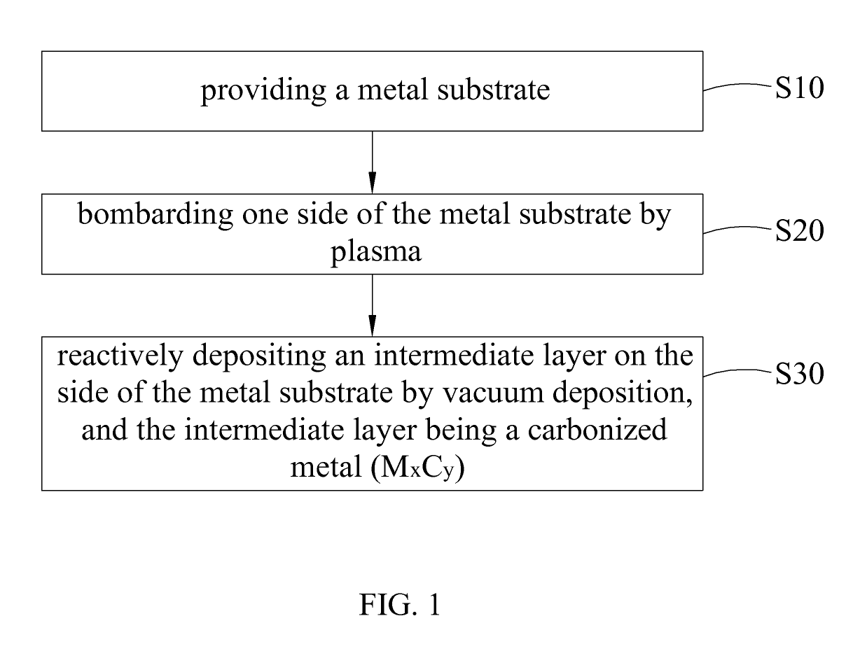

Please refer to FIG. 1, which illustrates a flow chart of the metal member manufacturing method in accordance with the present invention As shown in this figure, the metal member manufacturing method in accordance with the present invention comprises the following steps of:

(S10) providing a metal substrate;

(S20) bombarding one side of the metal substrate by plasma; and

(S30) reactively depositing an intermediate layer on the side of the metal substrate by vacuum deposition, and the intermediate layer being a carbonized metal (MₓC_{y}).

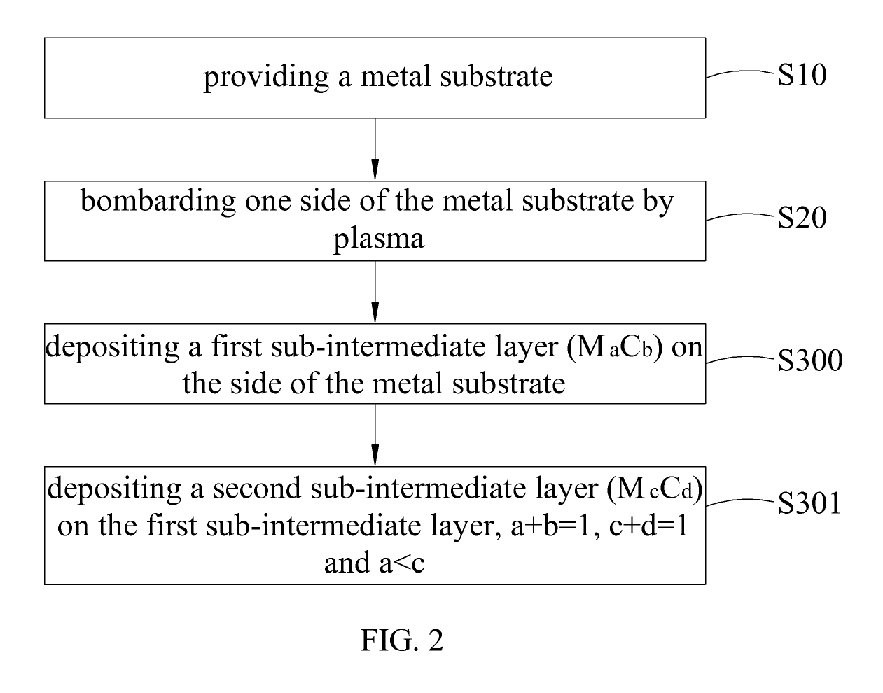

Please refer to FIG. 2, which illustrates another flow chart of the metal member manufacturing method in accordance with the present invention As shown in this figure, the step (S30) further comprises the following steps of:

(S300) depositing a first sub-intermediate layer (MₐC_{b}) on the side of the metal substrate; and

(S301) depositing a second sub-intermediate layer (M_{c}C_{d}) on the first sub-intermediate layer. Wherein, a+b=1, c+d=1 and a<c.

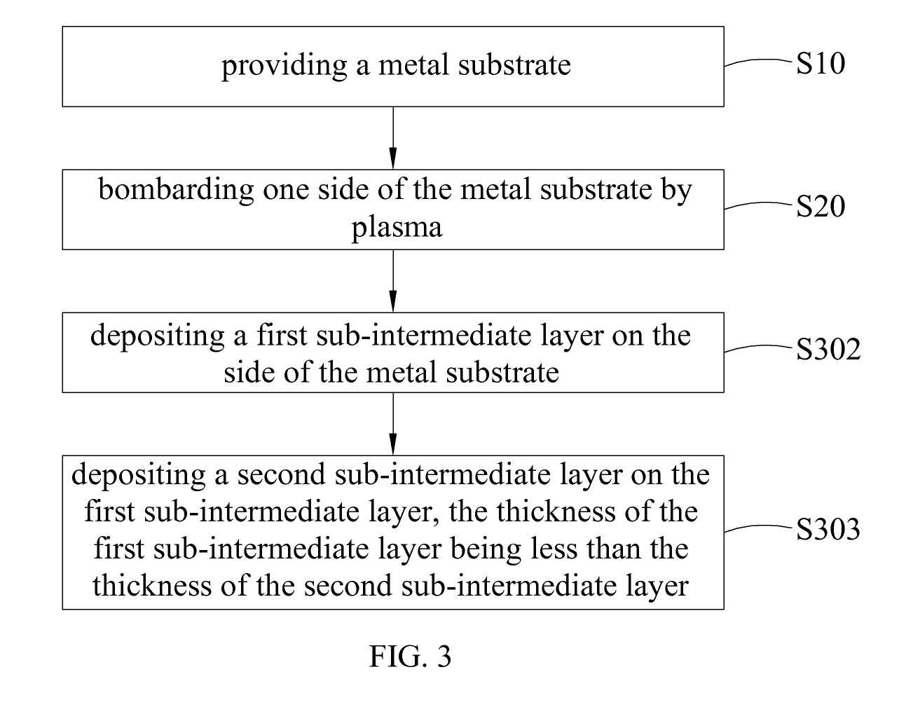

Please refer to FIG. 3, which illustrates still another flow chart of the metal member manufacturing method in accordance with the present invention As shown in this figure, the step (S30) could further comprises the following steps of:

(S302) depositing a first sub-intermediate layer on the side of the metal substrate; and

(S303) depositing a second sub-intermediate layer on the first sub-intermediate layer. Wherein, the thickness of the first sub-intermediate layer is less than the thickness of the second sub-intermediate layer.

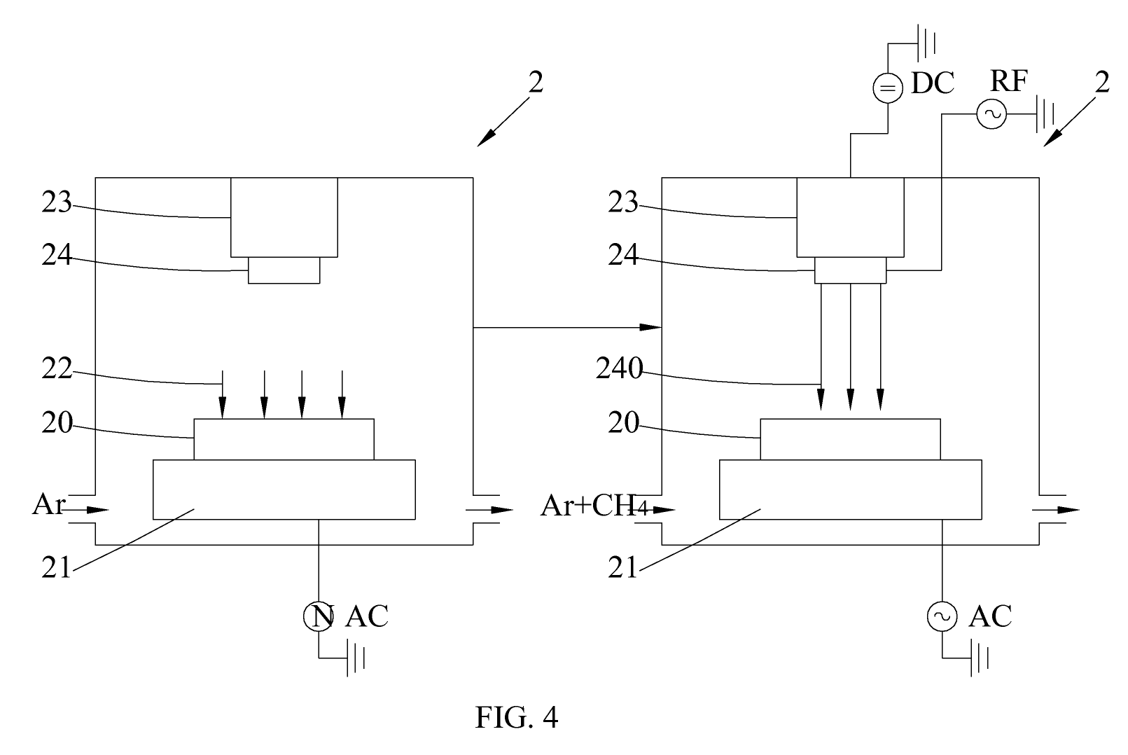

Please refer to FIG. 4, which illustrates a schematic diagram of the metal member manufacturing method in accordance with the present invention. As shown on the left side of this figure, a metal substrate 20 is set in a sputtering system 2, and is laid on a holder 20. After decreasing the working pressure to at least 10⁻⁴ Pa (background pressure), the argon (Ar) is flowed in with 50 mcc/min and the working pressure is adjusted to 10⁻²˜10⁻³ Pa. Then the holder 20 is given a DC or an AC voltage 3565 volt (with 100% power), so as to change the argon to a plasma 22 and bombard the metal substrate 20 about 5˜15 minutes as a surface cleaning process.

Then, as shown on the right side of this figure, now the reactive sputtering is processed: flowing in methane, acetylene or other gas having carbon as a carbon source of the carbonized metal layer; giving a DC or an AC voltage (such as RF) 125˜175 volt (with 85% power) and decreasing the bias power of the metal substrate to 15% so as to generate the plasma for sputtering a target material 24. The target material 24 is metallic such as iron, chromium, zinc, tungsten, or titanium. And then at least one metal atom 240 is sputtered from the surface of the target material 24 and moves toward the metal substrate 20. On the metal substrate 20, these metal atoms 240 thus chemically react with the carbon released form the methane or acetylene plasma, and a carbonized metal (MₓC_{y}) intermediate layer therefore is generated. The intermediate layer could be Fe₃C or other carbonized metals depend on the target materials.

When a intermediate layer with component gradient is preferred (stepS300˜S301), the power of the sputtering gun 23 is increased with a constant time interval, and the sputtered material from the target material 24 per unit time is thus increased so as to raise the metal content in the intermediate layer. Besides, the time interval also could be different when increasing the power of the sputtering gun 23 so as to generate a intermediate layer having both component and thickness gradient to increase the adhesion of the film effectively.

Finally, methane, acetylene or other gas having carbon is stopped to be provided, and thus the plasma gas is merely argon. Therefore, the metal atoms 240 generate no chemical reactions on the metal substrate 20, and only cover the intermediate layer with pure metal. This kind of connection method could effectively raise the adhesion between the metal layer and the metal substrate 20. In some preferred embodiments, the total thickness of the intermediate layer is 1˜5 nm.

The metal substrate could be a conventional industrial metal substrate; the voltage provided to the metal target 24 is about 5V˜300V and the power range of the sputtering gun is about 10%˜85%; the voltage provided to the metal substrate 20 is about 0V˜150V and the power range of the bias voltage is about 15%˜90%. The aforementioned parameters are depended with the members to be manufactured, and it is not limited in the present invention.

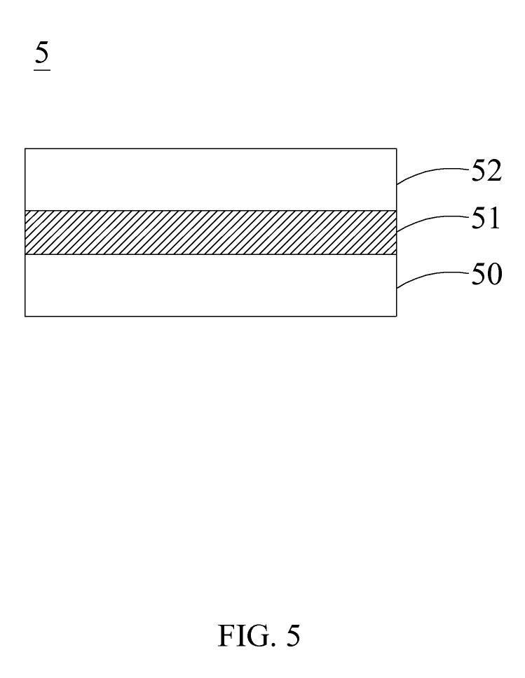

Please refer to FIG. 5, which illustrates a schematic diagram of the first embodiment of the metal member in accordance with the present invention. As shown in this figure, the metal member 5 comprises a metal substrate 50 and an intermediate layer 51. The intermediate layer 51 is disposed on the metal substrate 50 by reactive vacuum deposition, and the intermediate layer 51 could be a carbonized metal (MₓC_{y}). The metal substrate 50 could be a conventional industrial metal substrate such as stainless steel, and the intermediate layer 51 could be a layer deposited by the aforementioned method on the metal substrate 50. Besides, as shown in this embodiment, a metal layer 52 could further be disposed on the intermediate layer 51, and thus the intermediate layer 51 could effectively connect the metal layer 52 and the metal substrate 50.

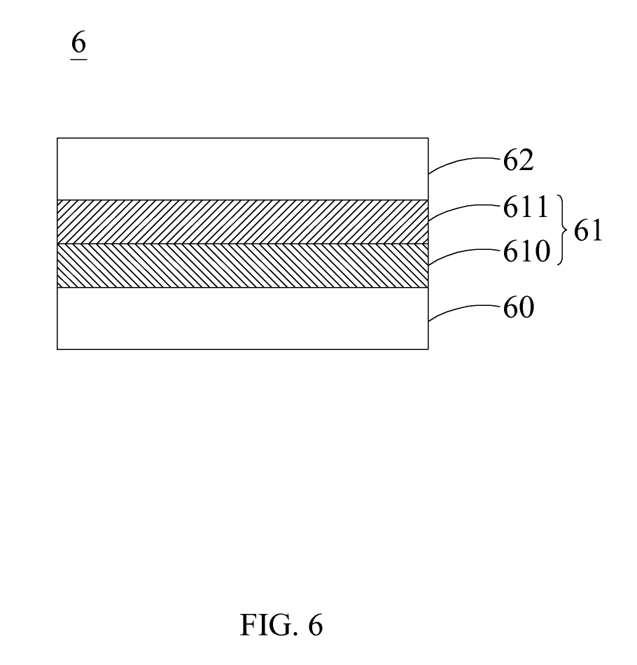

Please refer to FIG. 6, which illustrates a schematic diagram of the second embodiment of the metal member in accordance with the present invention. As shown in this figure, the metal member 6 comprises a metal substrate 60 and an intermediate layer 61. The intermediate layer 61 is disposed on the metal substrate 60 by reactive vacuum deposition, and the intermediate layer 61 could be a carbonized metal (MₓC_{y}). However, in this embodiment, the intermediate layer further comprises a first sub-intermediate layer (MₐC_{b}) 610 and a second sub-intermediate layer (M_{c}C_{d}) 611. The first sub-intermediate layer 610 is disposed on the side of the metal substrate 60, and the second sub-intermediate layer 611 is disposed on the first sub-intermediate layer 610, and a+b=1, c+d=1 and a<c. The present embodiment divides the whole intermediate layer 61 into pluralities of layer with different components, and the metal contain of the upper layer of the intermediate layer 61 is higher, and thus the residual stress on the interface of the metal substrate 60 and the metal layer 62 could be reduced by this slowly and gradually changing the metal contain in the intermediate layer 61 when connecting the metal substrate 60 and the metal layer 62, so as to further increase the adhesive ability of the metal layer 62.

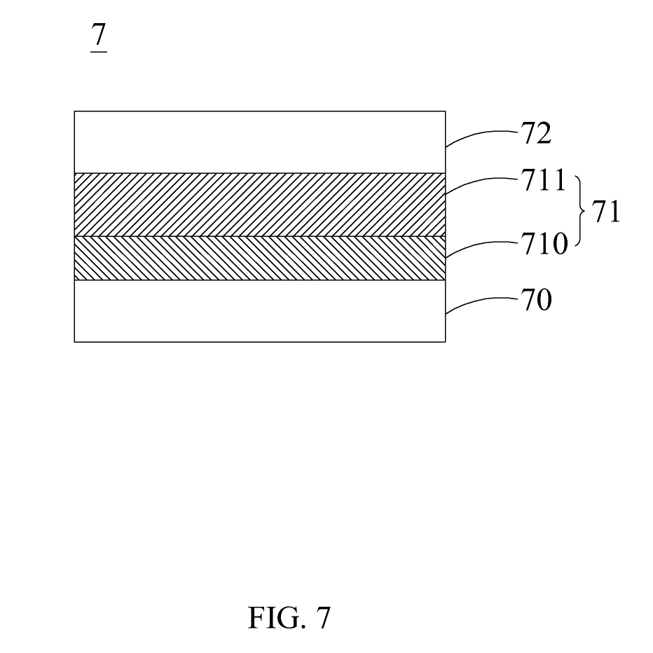

Please refer to FIG. 7, which illustrates a schematic diagram of the third embodiment of the metal member in accordance with the present invention. As shown in this figure, the metal member 7 comprises a metal substrate 70 and an intermediate layer 71. The intermediate layer 71 is disposed on the metal substrate 70 by reactive vacuum deposition, and the intermediate layer 71 could be a carbonized metal (MₓC_{y}). The intermediate layer further comprises a first sub-intermediate layer (MₐC_{b}) 710 and a second sub-intermediate layer (M_{c}C_{d}) 711. The first sub-intermediate layer 710 is disposed on the side of the metal substrate 70, and the second sub-intermediate layer 711 is disposed on the first sub-intermediate layer 710, and a+b=1, c+d=1 and a<c. However, in this embodiment, the thickness of the first sub-intermediate layer 710 is less than the thickness of the second sub-intermediate layer 711. This embodiment gradually changes the thickness and the metal concentration of the intermediate layer 71, and thus effectively increases the binding strength of the metal substrate 70 and the metal layer 72. Besides, the skilled man in the art should know that the thickness of the upper sub-intermediate layer is not limited to thicker than the lower sub-intermediate layer, the thickness of the upper sub-intermediate layer could also thinner than the lower sub-intermediate layer.

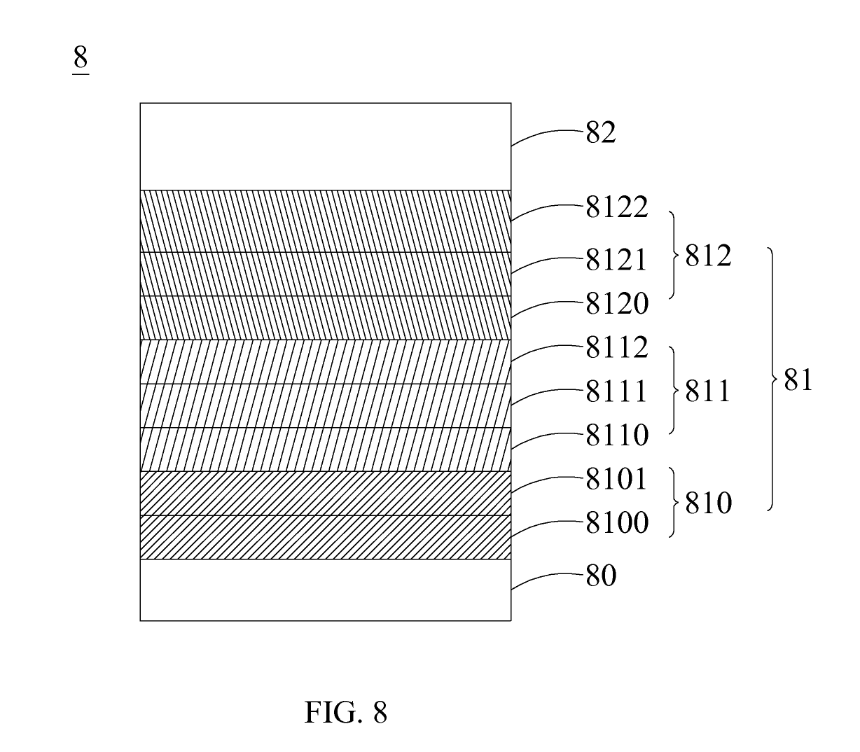

Please refer to FIG. 8, which illustrates a schematic diagram of the fourth embodiment of the metal member in accordance with the present invention. As shown in this figure, the metal member 8 comprises a metal substrate 80, an intermediate layer 81 and a metal layer 82. The intermediate layer 81 comprises a substrate-connected intermediate layer 810, a sub-intermediate layer 811 and a metal-connected intermediate layer 812. In the present embodiment, the metal substrate 80 is stainless steel and the metal layer 82 is titanium. In addition, the substrate-connected intermediate layer 810 comprises a first substrate-connected intermediate layer 8100 and a second substrate-connected intermediate layer 8101; the sub-intermediate layer 811 comprises a first sub-intermediate layer 8110, a second sub-intermediate layer 8111 and a third sub-intermediate layer 8112; the metal-connected intermediate layer 812 comprises a first metal-connected intermediate layer 8120, a second metal-connected intermediate layer 8121 and a third metal-connected intermediate layer 8122. It is describe right here that the substrate-connected intermediate layer 810, the sub-intermediate layer 811, the metal-connected intermediate layer 812 and their sub-layers are all the sub-intermediate layer described in the aforementioned embodiments, and the structure of the sub-intermediate layer is highly expanded in this embodiment.

In the present embodiment, the metal substrate 80 is heated to 225˜275° C. under the 10⁻⁴ Pa vacuum environment, the argon is provided with 25˜75 sccm, the substrate bias voltage is provided with 15˜25V and 80% power for 25˜35 seconds to clean the surface of the metal substrate 80. Then the sputtering gun of the stainless steel target is turned on with 100V and 80% power, and the acetylene is proved with 3˜7 sccm with decreasing the argon flow to 25˜65 sccm to process the reactive sputtering on the metal substrate 80 for 5˜15 minutes. Therefore, the carbonized metal such as iron carbide (first substrate-connected intermediate layer 8100) is formed. Further, the second substrate-connected intermediate layer 8101 is formed by raising the argon/acetylene ratio to 4:1 and decreasing the sputtering power toward the stainless steel target to 70% for 5˜15 minutes, and thus the iron content of the second substrate-connected intermediate layer 8101 is decreased.

After the aforementioned processes, the first sub-intermediate layer 8110, the second sub-intermediate layer 8111 and the third sub-intermediate layer 8112 are formed sequentially by reactive sputtering on the second substrate-connected intermediate layer 8101. These three layers are formed by providing another sputtering gun to bombard a titanium target so as to process the reactive sputtering simultaneously. However, the power and the voltage of the sputtering gun of the stainless steel are decreased when forming different sub-intermediate layers (60% [symbol] 40% [symbol] 20%, 80V [symbol] 50V [symbol] 20V), and the power and the voltage of the sputtering gun of the titanium are raised at the same time (20% [symbol] 40% [symbol] 60%, 20V [symbol] 50V [symbol] 80V). Thus, the iron carbide in these sub-intermediate layers is decreasing and the titanium carbide is increasing. The power and the voltage of each the sputtering gun are adjusted every 1015 minutes, and these sub-intermediate layers with same thickness but different metal concentration could be formed.

After that, the first metal-connected intermediate layer 8120, the second metal-connected intermediate layer 8121 and the third metal-connected intermediate layer 8122 are formed on the third sub-intermediate layer 8112 by further processing the reactive sputtering. In these stages, the sputtering gun of the stainless steel is turned off, and thus these metal-connected intermediate layers only have the titanium carbide. However, the forming parameters between the first metal-connected intermediate layer 8120 and the second metal-connected intermediate layer 8121 are the power of the sputtering gun (raise 10%) and the argon/acetylene ratio (form 3.5 to 8), and the thickness of these two layers is about the same by processing the reactive sputtering about 10˜15 minutes. When forming the third sub-intermediate layer 8112, the power of the sputtering gun is maintained but the argon/acetylene ratio is further increased to 10, thus the titanium concentration in the carbonized metal could be further raised. Besides, the sputtering time of the third sub-intermediate layer 8112 is about 25˜35 minutes, and it is the last intermediate layer.

Finally, a heat treatment is processed to the metal member 8 (without metal layer 82): the metal member 8 is heated to 550˜650° C. and keep about 10˜15 minutes, and then cooling down to the room temperature in the furnace. Then the metal layer 82 is formed on the third sub-intermediate layer 8112 by the sputtering process.

In this embodiment, two sets or more than two sets of intermediate layers and sub-intermediate layers are shown, and the metal concentration of these sub-intermediate layers are gradually changed. According to the Cross-Cut Adhesion Test (ASTM D3359, blade interval 1 mm, X-Y 10 grids), the present invention could highly raise the adhesion between the metal layer and the metal substrate form 3B (prior art) to 4B, and thus the present invention does increase the adhesion between the metal layer and the metal substrate substantially.

In summary, the adhesion between the deposited metal materials and the metal substrate could be increased by disposing an intermediate layer between the deposited metal materials and the metal substrate; and the problem of the prior art that the deposited metal materials could not fix on the metal substrate could be solved by further gradually changing the composition or the thickness of the intermediate layer in accordance with the present invention.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A metal member, comprising:
a metal substrate; and
an intermediate layer, disposed on one side of the metal substrate, and the intermediate layer being a carbonized metal (MₓC_{y}).

2. The metal member of claim 1, wherein the intermediate layer further comprises:
a first sub-intermediate layer (MₐC_{b}), disposed on the side of the metal substrate; and
a second sub-intermediate layer (M_{c}C_{d}), disposed on the first sub-intermediate layer;
wherein, a+b=1, c+d=1 and a<c.

3. The metal member of claim 1, wherein the intermediate layer further comprises:
a first sub-intermediate layer, disposed on the side of the metal substrate; and
a second sub-intermediate layer, disposed on the first sub-intermediate layer;
wherein, the thickness of the first sub-intermediate layer is less than the thickness of the second sub-intermediate layer.

4. The metal member of claim 1, wherein the intermediate layer further comprises:
a first sub-intermediate layer, disposed on the side of the metal substrate; and
a second sub-intermediate layer, disposed on the first sub-intermediate layer;
wherein, the thickness of the first sub-intermediate layer is bigger than the thickness of the second sub-intermediate layer.

5. The metal member of claim 1, wherein the thickness of the intermediate layer is 1˜5 nm.

6. The metal member of claim 1, wherein the metal member further comprises a metal layer disposed on the intermediate layer.

7. A metal member manufacturing method, comprising:
providing a metal substrate;
bombarding one side of the metal substrate by plasma; and
reactively depositing an intermediate layer on the side of the metal substrate by vacuum deposition, and the intermediate layer being a carbonized metal (MₓC_{y}).

8. The method of claim 7, wherein the step of depositing the intermediate layer further comprises:
depositing a first sub-intermediate layer (MₐC_{b}) on the side of the metal substrate; and
depositing a second sub-intermediate layer (M_{c}C_{d}) on the first sub-intermediate layer;
wherein, a+b=1, c+d=1 and a<c.

9. The method of claim 7, wherein the step of depositing the intermediate layer further comprises:
depositing a first sub-intermediate layer on the side of the metal substrate; and
depositing a second sub-intermediate layer on the first sub-intermediate layer;
wherein, the thickness of the first sub-intermediate layer is less than the thickness of the second sub-intermediate layer.

10. The method of claim 7, wherein the step of depositing the intermediate layer further comprises:
depositing a first sub-intermediate layer on the side of the metal substrate; and
depositing a second sub-intermediate layer on the first sub-intermediate layer;
wherein, the thickness of the first sub-intermediate layer is bigger than the thickness of the second sub-intermediate layer.

11. The method of claim 7, wherein the working pressure of the plasma bombardment and the vacuum deposition is 10⁻²˜10⁻⁴ Pa.

12. The method of claim 7, wherein the argon and an organic gas are provided as the plasma gas during the vacuum deposition.

13. The method of claim 12, wherein the organic gas is methane or acetylene.

14. The method of claim 7, wherein the thickness of the intermediate layer is 1˜5 nm.

15. The method of claim 7, wherein the method further comprises:
depositing a metal layer on the intermediate layer by vacuum deposition.
